(19) United States
(12) Patent Application Publication
(10) Pub. No.: US 2014/0187087 A1
(43) Pub. Date: Jul. 3, 2014

(54) RF CABLE CONNECTOR

(71) Applicant: TYCO ELECTRONICS CORPORATION, Berwyn, PA (US)

(72) Inventors: Jeffery Walter Mason, North Attleboro, MA (US); Wayne Stewart Alden, III, Whitman, MA (US)

(73) Assignee: Tyco Electronics Corporation, Berwyn, PA (US)

(21) Appl. No.: 13/733,456

(22) Filed: Jan. 3, 2013

(51) Int. Cl. H01R 13/646

(52) U.S. Cl. CPC H01R 13/646
USPC 439/607.36

(57) ABSTRACT

An RF cable connector includes a cable assembly having a plurality of RF cables bundled together and a buss bar coupled to the cable assembly. Each RF cable, which may be a twin axial RF cable, has a pair of signal conductors surrounded by an outer shield. The cable assembly has signal contacts terminated to ends of the signal conductors configured to be terminated to corresponding signal pads of a host circuit board. The buss bar has a base electrically coupled to each of the outer shields to electrically common the outer shields. The buss bar has ground tines extending from the base positioned between signal contacts and configured to be terminated to corresponding ground pads of the host circuit board.

### BACKGROUND OF THE INVENTION

The subject matter herein relates generally to radio frequency (RF) cable connectors.

Conventional cable connectors for use in handheld devices have small sizes to fit within the small space of the handheld device. Some known cable connectors are referred to as micro-coax assemblies, which use coaxial cables with small connectors for mating to a circuit board or other component within the device. The micro-coax assemblies use paddle cards that mate with card edge connectors on the circuit board. The coaxial cables are terminated to the paddle cards using a soldered connection, where the signal conductor is soldered to a signal pad on the paddle card and the outer shield of the coaxial cable is soldered to a ground pad or ground bar. The paddle card transitions the signals using traces to a mating edge of the paddle card, which is plugged into the card edge connector.

Using the paddle card and card edge connector adds cost and bulk to the system taking up valuable space in the device. Soldering each of the signal conductors and outer shield adds cost and complexity to the manufacture of the cable connector. Additionally, soldering of the signal conductors reduces the electrical performance of the signal conductors by affecting the impedance along the signal path.

A need remains for a reliable and cost effective cable connector.

### BRIEF DESCRIPTION OF THE INVENTION

In one embodiment, an RF cable connector is provided including a cable assembly having a plurality of RF cables bundled together and a buss bar coupled to the cable assembly. Each RF cable has a pair of signal conductors surrounded by an outer shield. The cable assembly has signal contacts terminated to ends of the signal conductors configured to be terminated to corresponding signal pads of a host circuit board. The buss bar has a base electrically coupled to each of the outer shields to electrically common the outer shields. The buss bar has ground tines extending from the base positioned between signal contacts and configured to be terminated to corresponding ground pads of the host circuit board.

Optionally, the signal contacts may be terminated to the signal conductors via a solderless connection. The signal contacts may have spring beams configured to be spring biased against the signal pads of the host circuit board. The signal contacts may include mating interfaces configured to be surface mounted to the corresponding signal pads of the host circuit board and the ground tines may include mating interfaces configured to be surface mounted to the corresponding ground pads of the host circuit board at separable interfaces. The ground tines may extend forward of the signal contacts such that the mating interfaces of the ground tines are positioned further from the signal conductors than the mating interfaces of the signal contacts.

Optionally, the ground tines may be electrically connected to the host circuit board without the use of a paddle card therebetween. The buss bar may be a stamped and formed structure with the ground tines integrally formed with the base. The ground tines may provide electrical shielding along ground planes defined between pairs of the signal contacts and corresponding signal conductors. The buss bar may include an insulator between the base and the signal contacts and signal conductors to electrically isolate the base from the signal contacts and the signal conductors.

Optionally, each RF cable may comprise a twin axial RF cable including an insulator between the signal conductor and corresponding outer shield, a jacket surrounding each outer shield and a sleeve surrounding both jackets of each pair. The outer shield may be exposed forward of the corresponding jackets and sleeve and the buss bar may directly engaging the exposed portions of the outer shields.

In another embodiment, an RF cable connector is provided having a cable assembly having a plurality of twin axial RF cables bundled together and a buss bar coupled to the cable assembly. Each twin axial RF cable has a pair of signal conductors surrounded by an outer shield. The cable assembly has signal contacts terminated to ends of the signal conductors configured to be surface mounted to corresponding signal pads of a host circuit board. The buss bar has a base electrically coupled to each of the outer shields to electrically common the outer shields. The buss bar has ground tines extending from the base positioned between signal contacts. The ground tines are configured to be surface mounted to corresponding ground pads of the host circuit board. The RF cable connector includes an insulator having a cable end, a plurality of tine channels and a plurality of contact channels. The insulator is positioned forward of the cable assembly with the signal contacts being loaded into corresponding contact channels and with the ground tines being loaded into corresponding tine channels. The insulator supports the signal contacts and the ground tines for surface mounting to the host circuit board. The RF cable connector includes a housing receiving the insulator that has a latch extending therefrom. The RF cable connector includes a host circuit board having signal pads and ground pads at a mating area of the host circuit board and an EMI hood covering the mating area. The housing is loaded into the EMI hood with the signal contacts engaging corresponding signal pads and with the ground tines engaging corresponding ground pads. The latch of the housing engages the EMI hood to secure the housing to the EMI hood.

### BRIEF DESCRIPTION OF THE DRAWINGS

FIG. 1 illustrates an RF cable connector formed in accordance with an exemplary embodiment.

FIG. 2 is an exploded view of the RF cable connector formed in accordance with an exemplary embodiment.

FIG. 3 is an enlarged view of the portion of a cable assembly of the RF cable connector.

FIG. 4 is a bottom perspective view of the cable assembly with a buss bar coupled to cables of the cable assembly.

FIG. 5 illustrates the RF cable connector partially assembled.

FIG. 6 is a side view of the RF cable connector in an assembled state.

FIG. 7 is a bottom view of the RF cable connector.

FIG. 8 illustrates the RF cable connector poised for mating with a host circuit board.

FIG. 9 illustrates the RF cable connector mated with the host circuit board.

FIG. 10 is a side view of the RF cable connector mated with the host circuit board.

FIG. 11 is a cross sectional view of the RF cable connector mounted to the host circuit board taken along a ground tine of the buss bar.

FIG. 12 is a cross sectional view of the RF cable connector mounted to the host circuit board taken along a signal contact of the cable assembly.

FIG. 13 illustrates a buss bar formed in accordance with another exemplary embodiment.

### DETAILED DESCRIPTION OF THE INVENTION

FIG. 1 illustrates a radio frequency (RF) cable connector 100 formed in accordance with an exemplary embodiment and configured to be coupled directly to a host circuit board 102. In an exemplary embodiment, the RF cable connector 100 is a high speed, high density, controlled impedance cable connector. The RF cable connector 100 includes a housing 104 terminated to an end of a cable assembly 106. For purposes of the present disclosure, the term “RF” is used broadly to include a wide range of electromagnetic transmission frequencies including, for instance, those falling within the radio frequency, microwave or millimeter wave frequency ranges.

The host circuit board 102 includes front edge 110 where the cable assembly 106 is connected to the host circuit board 102. The host circuit board 102 includes a mounting surface 112 extending from the front edge 110. The RF cable connector 100 is coupled to the mounting surface 112 of the host circuit board 102. In an exemplary embodiment, the host circuit board 102 includes one or more electronic components 114 coupled thereto. The electronic components 114 may process data signals sent to and/or received from the RF cable connector 100. The host circuit board 102 includes conductors or traces connecting the RF cable connector 100 with the electronic components 114.

In an exemplary embodiment, the host circuit board 102 includes an EMI hood 116 covering a mating area of the host circuit board 102. The EMI hood 116 provides electrical shielding for the RF cable connector 100 and signal conductors of the host circuit board 102. The EMI hood 116 includes a receptacle 118 that receives the housing 104 of the RF cable connector 100. In an exemplary embodiment, the housing 104 may be secured to the EMI hood 116 to secure the RF cable connector 100 to the host circuit board 102. In an exemplary embodiment, the RF cable connector 100 is separable from the host circuit board 102, wherein the RF cable connector 100 may be mated and unmated from the host circuit board 102.

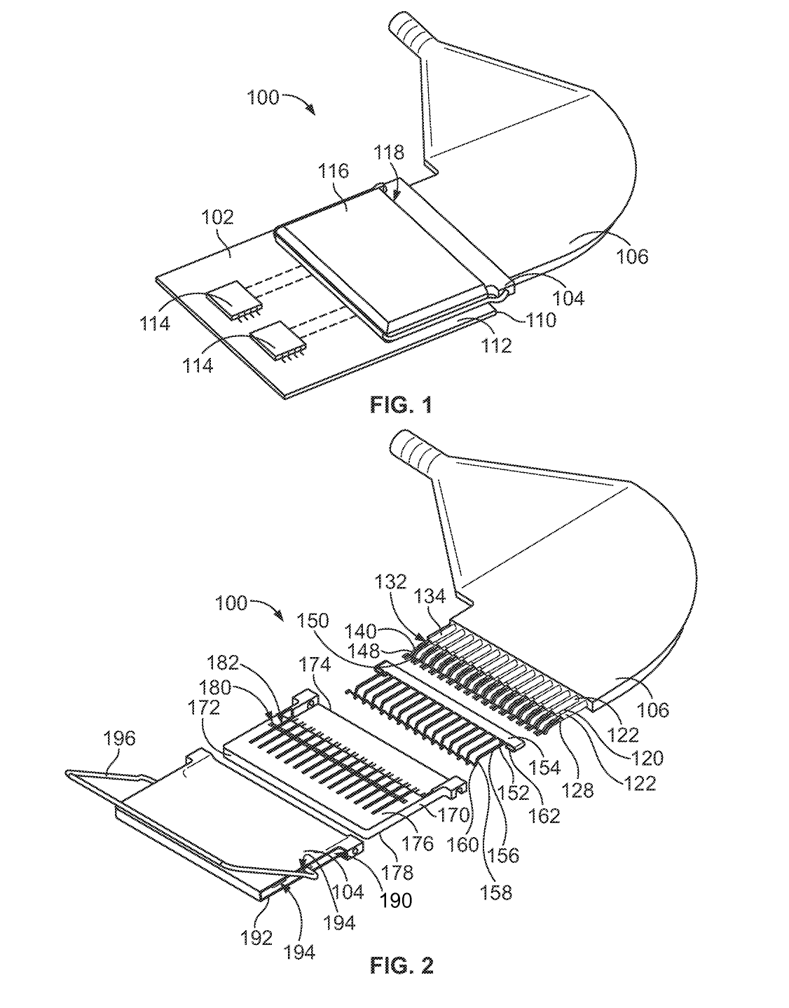

FIG. 2 is an exploded view of the RF cable connector 100 formed in accordance with an exemplary embodiment. The cable assembly 106 includes a support 120 that supports a plurality of cables 122. In an exemplary embodiment, the cables 122 are twin axial RF cables; however, other types of cables such as a coaxial cable, a ribbon cable, a flex cable, or other types of cables may be used in alternative embodiments. Each cable 122 is bundled together by the support 120. The support 120 may provide insulation between the cables 122. Optionally, the support 120 may provide electrical shielding from the cables 122. The support 120 may be a ribbon holding the cables 122 together.

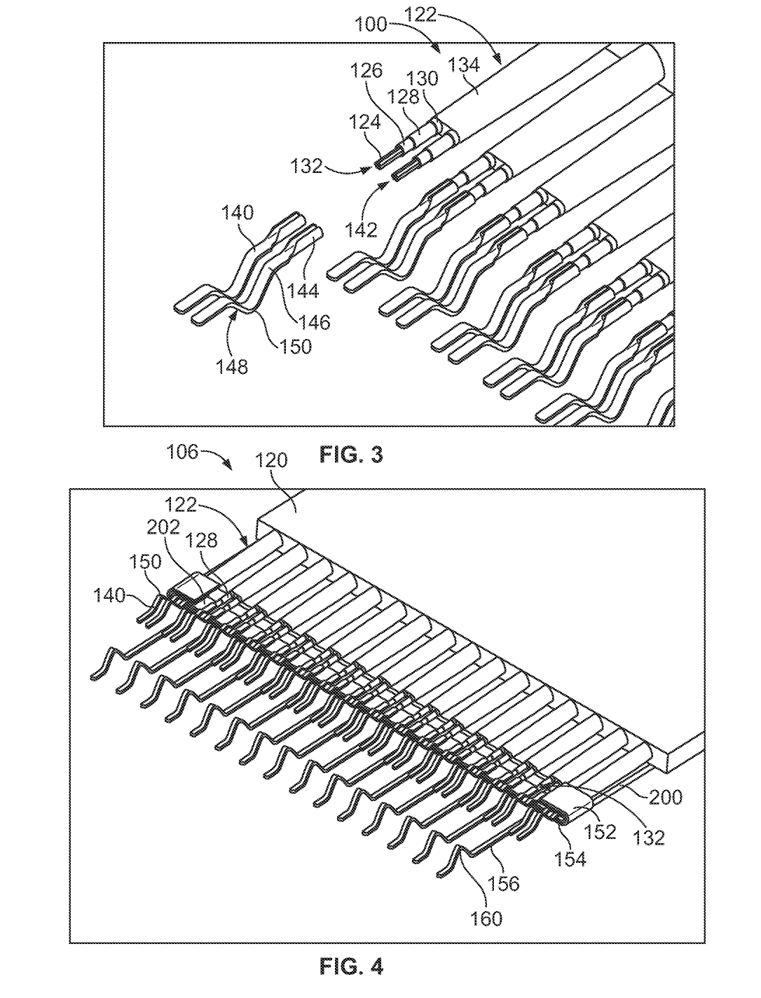

FIG. 3 is an enlarged view of the portion of the cable assembly 106. FIG. 3 illustrates a plurality of the RF cables 122. In the illustrated embodiment, each of the RF cables 122 includes a pair of signal conductors 124. A signal conductor 124 may be a single wire or made of multiple finer gauge wires, according to various embodiments. The signal conductors 124 are surrounded by insulators 126. The insulators 126 are surrounded by outer shields 128. The outer shields 128 provide electrical shielding along the lengths of the signal conductors 124. The outer shields 128 and corresponding signal conductors 124 are arranged in a coaxial manner. The outer shields 128 are surrounded by jackets 130. The signal conductor 124, insulator 126, outer shield 128, and jacket 130 coaxially arranged define an individual wire 132. As noted above, in an exemplary embodiment, each of the RF cables 122 includes a pair of wires 132. Both wires 132 are held within a common sleeve 134 of the RF cable 122. The sleeve 134 is supported by the support 120.

The cables 122 are prepared by exposing portions of the cables 122 for termination to other components. For example, portions of the outer shield 128 are exposed beyond the jacket 130 and sleeves 134. Portions of the signal conductors 124 are exposed beyond the outer shields 128. In an exemplary embodiment, signal contacts 140 are terminated to ends 142 of the signal conductors 124. Optionally, the signal contacts 140 may be solderlessly connected, such as being crimped, to the signal conductors 124. The signal contacts 140 form part of data communication path of each signal conductor 124. The signal contacts 140 are configured to be directly electrically coupled to the host circuit board 102 (shown in FIG. 1) at a separable interface.

In an exemplary embodiment, each signal contact 140 includes a crimp barrel 144 at an end thereof. A beam 146 extends from the crimp barrel 144. Optionally, the beam 146 may define a spring beam configured to be deflectable and spring biased against the host circuit board 102 to define a separable mating interface with the host circuit board 102. The beam 146 has a mating portion 148 defining a separable mating interface 150. The mating interface 150 is configured to engage the host circuit board 102. In the illustrated embodiment, the mating portion 148 is bent downward into a V-shape to define the mating interface 150 at the base of the V-shaped area. The beam 146 may have other shapes in alternative embodiments. In an exemplary embodiment, the signal contact 140 is stamped and formed.

FIG. 2 illustrates the cable assembly 106 with the signal contacts 140 terminated to the ends of each of the wires 132 of the RF cables 122. The cable assembly 106 includes a buss bar 152 configured to be electrically connected to each of the wires 132 to electrically common the outer shields 128 of the wires 132.

The buss bar 152 includes a base 154 extending the width of the cable assembly 106. The buss bar 152 includes ground tines 156 extending forward from the base 154. The ground tines 156 are positioned between corresponding signal contact 140. For example, each ground tine 156 may extend between otherwise adjacent pairs of the signal contacts 140. The ground tines 156 are configured to be surface mounted to the host circuit board 102 at a separable mating interface when the RF cable connector 100 is coupled to the host circuit board 102 (shown in FIG. 1). In alternative embodiments, the ground tines 156 may be configured to be terminated to the host circuit board 102 by other means or processes, including through hole mounting, soldering, mating with a complementary mating contact and the like. The ground tines 156 may be permanently connected to the host circuit board 102 rather than being terminated at a separable mating interface, such as by soldering to the host circuit board 102.

In an exemplary embodiment, the buss bar 152 is a stamped and formed structure. The ground tines 156 are integral with the base 154. The ground tines 156 include mating portions 158 proximate to ends thereof. The mating portions 158 define mating interfaces 160 configured to be electrically connected to the host circuit board 102. The mating interfaces 160 define separable mating interfaces configured to be repeatedly mated to and unmated from the host circuit board 102. In the illustrated embodiment, the mating portions 158 are bent downward in a V-shape to define the mating interfaces 160 at the bottom of the V-shaped area. Other shapes are possible in alternative embodiments for the ground tines 156.

Optionally, the buss bar 152 may include tabs 162 at ends thereof that are used to secure the buss bar 152 to the cable assembly 106. The tabs 162 may be folded over around a bottom side of the cable assembly 106. Other securing features may be used in alternative embodiments to secure the buss bar 152 to the cable assembly 106.

The RF cable connector 100 includes an insulator 170 used to hold the signal contacts 140 and the ground tines 156 of the buss bar 152. The insulator 170 is configured to be loaded into the housing 104. The housing 104 provides electrical shielding for the signal contact 140 received in the insulator 170. The insulator 170 is made from an insulative material, such as a plastic material. The insulator 170 has a front end 172 and a cable end 174 opposite the front end 172. The insulator 170 has a top 176 and a bottom 178. During assembly, the cable assembly 106 is loaded into the cable end 174 of the insulator 170.

The insulator 170 includes contact channels 180 that receive corresponding signal contacts 140. The insulator 170 includes tine channels 182 that receive corresponding ground tines 156. The insulator 170 holds the proper spacing of the signal contacts 140 and the ground tines 156 such that the mating interfaces 150, 160 are exposed and properly positioned for mating with the host circuit board 102. In the illustrated embodiment, the insulator 170 is generally rectangular in shape, however other shapes are possible in alternative embodiments.

The housing 104 is configured to receive the insulator 170 and portions of the cable assembly 106. The housing 104 may be manufactured from a metallic material. The housing 104 provides electrical shielding for the signal contacts 140. Optionally, the housing 104 may be directly connected to the buss bar 152 to create a ground path between the buss bar 152 and the housing 104.

The housing 104 defines a receptacle 190. The insulator 170 is loaded into the receptacle 190. A bottom 192 of the housing 104 may include openings 194 that receive the mating portion 148 of the signal contacts 140 and mating portion 158 of the ground tines 156. The openings 194 expose the signal contacts 140 and ground tines 156 for connection to the host circuit board 102.

In an exemplary embodiment, the housing 104 includes a latch 196 coupled thereto. Optionally, the latch 196 may be rotatably coupled to the housing 104. Other types of latches or securing features may be used in alternative embodiments for securing the RF cable connector 100 to the host circuit board 102.

FIG. 4 is a bottom perspective view of the cable assembly 106 with the buss bar 152 coupled to the RF cables 122. In an exemplary embodiment, the cable assembly 106 includes a holder 200 extending forward from the support 120. Optionally, the holder 200 may be part of the support 120. The holder 200 is used to hold the RF cables 122. Optionally, the holder 200 may include adhesive to secure the RF cables 122 in position along the holder 200. The holder 200 may be supportive of one side of the cables 122. Alternatively, the holder 200 may support two sides of the cables 122. For example, two holders 200 may be used, one on top and one on bottom of the RF cables 122.

The buss bar 152 is secured to the RF cables 122. Optionally, the buss bar 152 may be clamped onto one or more of the RF cables 122 and/or signal contacts 140. The buss bar 152 may be secured to the holder 200. The base 154 directly engages the outer shields 128 of each of the wires 132 to electrically common each of the outer shields 128. Optionally, the outer shields 128 may be soldered to the base 154. The outer shields 128 may be mechanically and electrically connected to the base 154 by other means or processes in alternative embodiments. For example, the base 154 may be welded to the outer shields 128, such as by ultrasonically welding the base 154 to the outer shield 128.

In an exemplary embodiment, an insulator 202 is positioned between the base 154 and each of the signal contact 140 and signal conductors 124. For example, the insulator 202 may be applied to an inner surface of the base 154 forward of the area where the outer shields 128 are connected to the base 154. Optionally, the insulator 202 may be secured to the base 154 by adhesive. The insulator 202 may be a film or a tape applied to the base 154. The insulator 202 electrically isolates the buss bar 152 from the signal conductors 124 and the signal contacts 140.

When assembled, the ground tines 156 extend forward from the base 154 along the signal contacts 140. In an exemplary embodiment, the ground tines 156 extend forward of the distal ends of the signal contacts 140. For example, the ground tines 156 may be longer than the signal contacts 140 to position the mating interfaces 160 of the ground tines 156 forward of the mating interfaces 150 of the signal contacts 140. In an exemplary embodiment, the ground tines 156 are positioned between the corresponding signal contacts 140. For example, the ground tines 156 may be positioned between pairs of the signal contacts 140. The ground tines 156 may be positioned along ground planes extending between pairs of the signal contacts 140. Optionally, portions of the ground tines 156 may be vertically aligned (e.g., coplanar with) portions of the signal contacts 140.

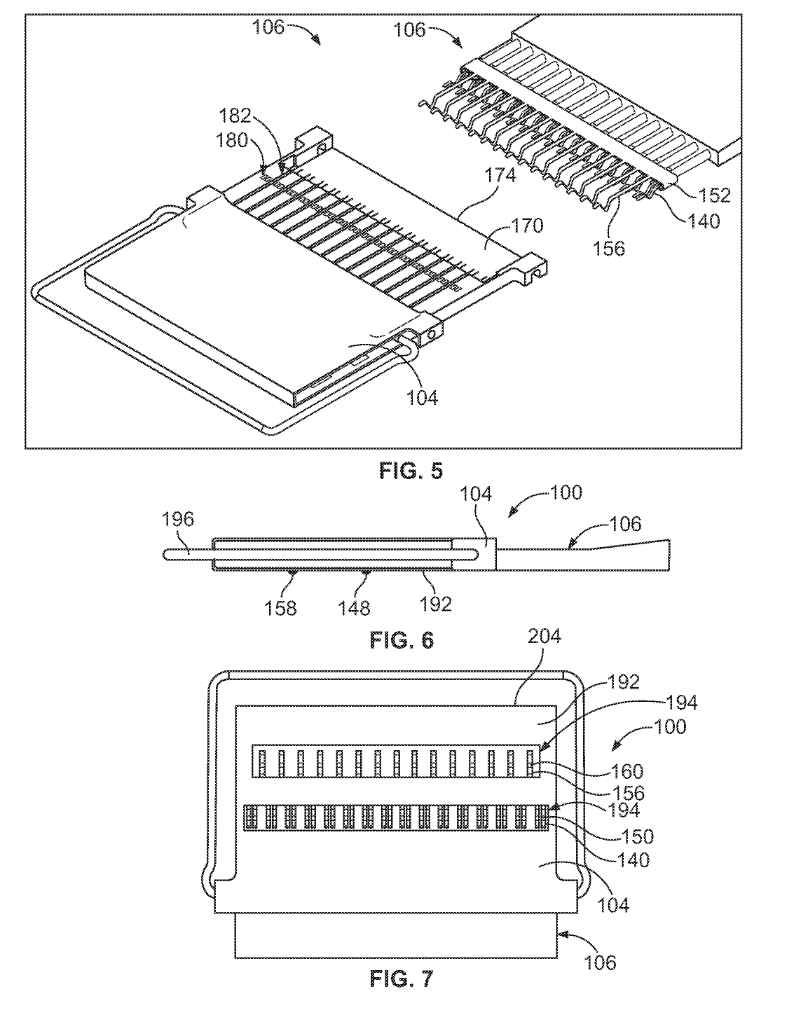

FIG. 5 illustrates the RF cable connector 100 partially assembled. The cable assembly 106 and buss bar 152 are assembled and poised for loading into the insulator 170. The insulator 170 is poised for loading into the housing 104. The ground tines 156 and signal contacts 140 are in line with corresponding tine channels 182 and contact channels 180 and are loaded therein from the cable end 174 of the insulator 170. Optionally, the signal contacts 140 and ground tines 156 may be loaded into the insulator 170 from above as oppose to from behind. Once the cable assembly 106 and buss bar 152 are loaded into the insulator 170, the sub assembly may be loaded into the housing 104.

FIG. 6 is a side view of the RF cable connector 100 in an assembled state. The cable assembly 106 extends rearward from the housing 104. The mating portions 148, 158 are exposed below the bottom 192 of the housing 104 for mating with the host circuit board 102 (shown in FIG. 1). The latch 196 is used to secure the RF cable connector 100 to the host circuit board 102.

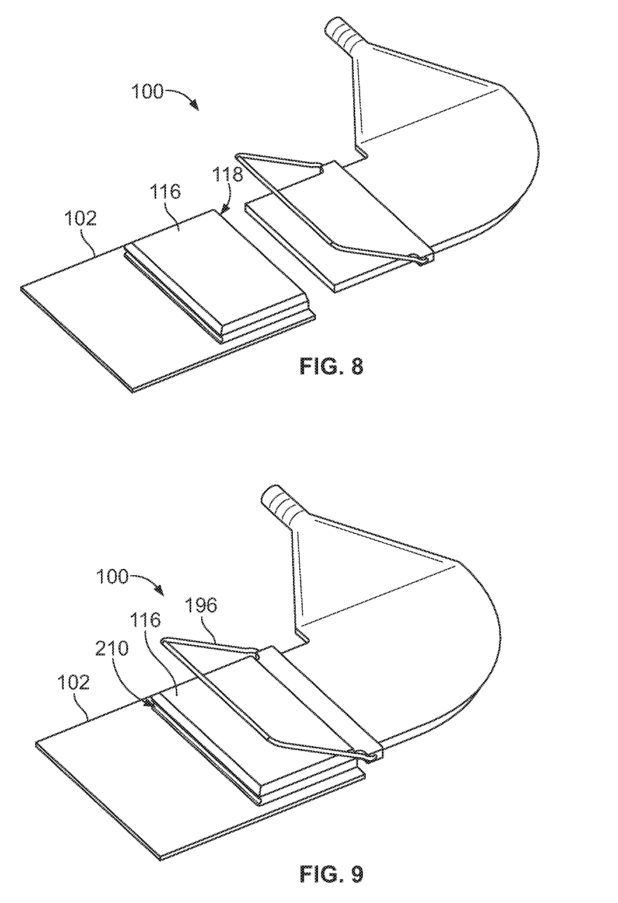

FIG. 7 is a bottom view of the RF cable connector 100. The signal contacts 140 and ground tines 156 are exposed through the openings 194 in the bottom 192 of the housing 104. In an exemplary embodiment, the mating interfaces 150 of the signal contacts 140 are positioned closer to the cable assembly 106 and rearward of the mating interfaces 160 of the ground tine 156. The mating interfaces 160 of the ground tines 156 are positioned closer to a mating end 204 of the RF cable connector 100. When the RF cable connector 100 is mated with the host circuit board 102 (shown in FIG. 1), the ground tines 156 are configured to mate with the host circuit board 102 prior to the signal contacts 140 mating with the host circuit board 102. The RF cable connector 100 may thus be grounded prior to making any signal connection.

FIG. 8 illustrates the RF cable connector 100 poised for mating with the host circuit board 102. The RF cable connector 100 is aligned with the receptacle 118 of the EMI hood 116. The RF cable connector 100 is plugged into the EMI hood 116 such that the signal contacts 140 and ground tines 156 (both shown in FIG. 7) mate with the host circuit board 102.

FIG. 9 illustrates the RF cable connector 100 mated with the host circuit board 102. In an exemplary embodiment, the EMI hood 116 includes a catch 210 defined by a groove on a rear side of the EMI hood 116. The latch 196 is configured to be rotated until the latch 196 is received in the catch 210. The latch 196 secures the RF cable connector 100 to the EMI hood 116 and host circuit board 102. The latch 196 resists removal of the RF cable connector 100 from the host circuit board 102.

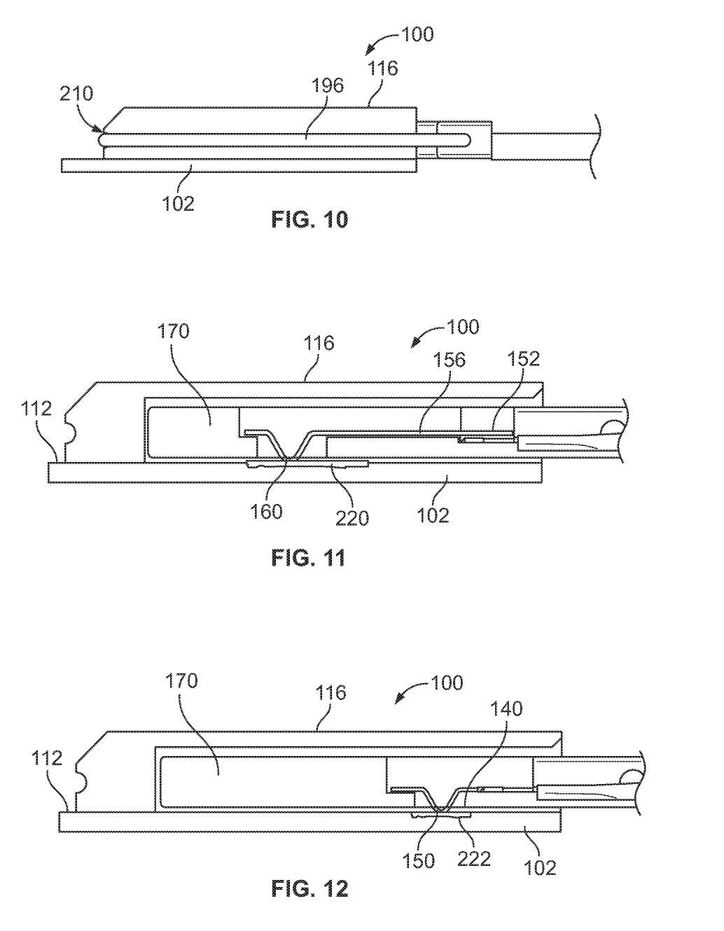

FIG. 10 is a side view of the RF cable connector 100 mated with the host circuit board 102. The latch 196 is received in the catch 210 to secure the RF cable connector 100 to the host circuit board 102 and the EMI hood 116. The RF cable connector 100 may be removed from the host circuit board 102 by unlatching the latch 196 from the catch 210 and pulling the RF cable connector 100 out of the EMI hood 116.

FIG. 11 is a cross sectional view of the RF cable connector 100 mounted to the host circuit board 102 taken along one of the ground tines 156. FIG. 11 illustrates one of the ground tines 156 mated with the host circuit board 102. In an exemplary embodiment, the host circuit board 102 includes a ground pad 220 on the mounting surface 112. The mating interface 160 engages the ground pad 220 to electrically connect the ground tine 156 to the host circuit board 102. The buss bar 152 is electrically grounded by the connection to the ground pad 220 of the host circuit board 102. In an exemplary embodiment, the ground tine 156 is deflectable within the insulator 170. For example, when the RF cable connector 100 is plugged into the EMI hood 116, the ground tine 156 may be deflected outward causing the ground tine 156 to be spring biased downward against the ground pad 220 of the host circuit board 102. The spring force of the ground tine 156 ensures electrical connection between the ground tine 156 and the ground pad 220.

FIG. 12 is a cross sectional view of the RF cable connector 100 mounted to the host circuit board 102 taken along one of the signal contacts 140. FIG. 12 illustrates one of the signal contacts 140 mated with the host circuit board 102. In an exemplary embodiment, the host circuit board 102 includes a signal pad 222 on the mounting surface 112. The mating interface 150 engages the signal pad 222 to electrically connect the signal contact 140 to the host circuit board 102. In an exemplary embodiment, the signal contact 140 is deflectable within the insulator 170. For example, when the RF cable connector 100 is plugged into the EMI hood 116, the signal contact 140 may be deflected outward causing the signal contact 140 to be spring biased downward against the signal pad 222 of the host circuit board 102. The spring force of the signal contact 140 ensures electrical connection between the signal contact 140 and the signal pad 222. In alternative embodiments, the signal contact 140 may be configured to be terminated to the host circuit board 102 by other means or processes, including through hole mounting, soldering, mating with a complementary mating contact and the like. The signal contact 140 may be permanently connected to the host circuit board 102 rather than being terminated at a separable mating interface, such as by soldering to the host circuit board 102.

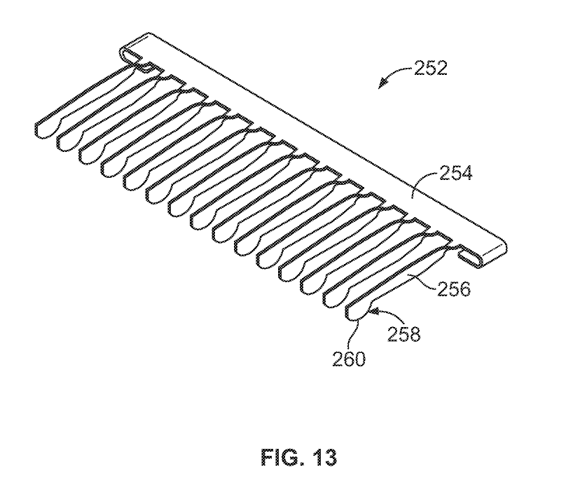

FIG. 13 illustrates a buss bar 252 fanned in accordance with another exemplary embodiment. The buss bar 252 may be similar to the buss bar 152 (shown in FIG. 2) and may be used in place of the buss bar 152 on the cable assembly 106. For example, the buss bar 252 may be electrically connected to each of the outer shields 128 (shown in FIG. 2) to electrically common the outer shields 128.

The buss bar 252 includes a base 254 and ground tines 256 extending forward from the base 254. The ground tines 256 are different than the ground tines 156 (shown in FIG. 2) in that the ground tines 256 are wider vertically such that a greater amount of metal material may be positioned between corresponding signal contact 240. For example, each ground tine 256 may be stamped with the base 254 and then twisted such that the ground tines 256 extend vertically. The ground tines 256 are configured to be surface mounted to the host circuit board 102 (shown in FIG. 1); however, the ground tines 256 may be terminated by other connections in alternative embodiments.

The ground tines 256 include mating portions 258 proximate to ends thereof. The mating portions 258 define mating interfaces 260 configured to be electrically connected to the host circuit board 102. The mating interfaces 260 define separable mating interfaces configured to be repeatedly mated to and unmated from the host circuit board 102. In the illustrated embodiment, the mating portions 258 are formed by bumps or protrusions that extend downward to define the mating interfaces 260 at the bottom of the protrusion. Other shapes are possible in alternative embodiments for the ground tines 256.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. An RF cable connector comprising:
a cable assembly having a plurality of RF cables bundled together, each RF cable having a pair of signal conductors, each signal conductor being surrounded by an outer shield, the cable assembly having signal contacts terminated to ends of the signal conductors, the signal contacts being configured to be terminated to corresponding signal pads of a host circuit board; and
a buss bar coupled to the cable assembly, the buss bar having a base electrically coupled to each of the outer shields to electrically common the outer shields, the buss bar having ground tines extending from the base, the ground tines being positioned between signal contacts, the ground tines being configured to be terminated to corresponding ground pads of the host circuit board.

2. The connector of claim 1, wherein the signal contacts are terminated to the signal conductors via a solderless connection.

3. The connector of claim 1, wherein the signal contacts have spring beams configured to be spring biased against the signal pads of the host circuit board.

4. The connector of claim 1, wherein the signal contacts include mating interfaces configured to be surface mounted to the corresponding signal pads of the host circuit board and the ground tines include mating interfaces configured to be surface mounted to the corresponding ground pads of the host circuit board at separable interfaces, the ground tines extending forward of the signal contacts such that the mating interfaces of the ground tines are positioned further from the signal conductors than the mating interfaces of the signal contacts.

5. The connector of claim 1, wherein the ground tines are configured to be electrically connected to the host circuit board without the use of a paddle card therebetween.

6. The connector of claim 1, wherein the buss bar is a stamped and formed structure with the ground tines integrally formed with the base.

7. The connector of claim 1, wherein the ground tines provide electrical shielding along ground planes defined between pairs of the signal contacts and corresponding signal conductors.

8. The connector of claim 1, wherein the buss bar includes an insulator between the base and the signal contacts and signal conductors to electrically isolate the base from the signal contacts and the signal conductors.

9. The connector of claim 1, wherein each RF cable comprises a twin axial RF cable including an insulator between the signal conductor and corresponding outer shield, a jacket surrounding each outer shield and a sleeve surrounding both jackets of each pair, the outer shield being exposed forward of the corresponding jackets and sleeve, the buss bar directly engaging the exposed portions of the outer shields.

10. The connector of claim 1, further comprising an insulator holding the signal contacts and ground tines for surface mounting to the host circuit board and a housing that receives the insulator, the housing being metallic and providing electrical shielding around the signal contacts.

11. The connector of claim 1 further comprising:
an insulator having a cable end, the insulator having a plurality of tine channels and a plurality of contact channels, the insulator being positioned forward of the cable assembly with the signal contacts being loaded into corresponding contact channels and with the ground tines being loaded into corresponding tine channels, the insulator supporting the signal contacts and the ground tines for termination to the host circuit board.

12. The connector of claim 11, wherein the insulator has a bottom configured to face the host circuit board, mating portions of the signal contacts and the ground tines being exposed at the bottom for termination to the host circuit board.

13. The connector of claim 11, wherein the signal contacts are terminated to the signal conductors via a solderless connection.

14. The connector of claim 11, wherein the signal contacts include mating interfaces configured to be terminated to the corresponding signal pads of the host circuit board and the ground tines include mating interfaces configured to be terminated to the corresponding ground pads of the host circuit board at separable interfaces, the ground tines extending forward of the signal contacts such that the mating interfaces of the ground tines are positioned further from the signal conductors than the mating interfaces of the signal contacts.

15. The connector of claim 11, wherein the ground tines are configured to be electrically connected to the host circuit board without the use of a paddle card therebetween.

16. The connector of claim 11, wherein the buss bar is a stamped and formed structure with the ground tines integrally formed with the base.

17. An RF cable connector comprising:
a cable assembly having a plurality of twin axial RF cables bundled together, each twin axial RF cable having a pair of signal conductors, each signal conductor being surrounded by an outer shield, the cable assembly having signal contacts terminated to ends of the signal conductors, the signal contacts being configured to be surface mounted to corresponding signal pads of a host circuit board;
a buss bar coupled to the cable assembly, the buss bar having a base electrically coupled to each of the outer shields to electrically common the outer shields, the buss bar having ground tines extending from the base, the ground tines being positioned between signal contacts, the ground tines being configured to be surface mounted to corresponding ground pads of the host circuit board;
an insulator having a cable end, the insulator having a plurality of tine channels and a plurality of contact channels, the insulator being positioned forward of the cable assembly with the signal contacts being loaded into corresponding contact channels and with the ground tines being loaded into corresponding tine channels, the insulator supporting the signal contacts and the ground tines for surface mounting to the host circuit board;
a housing receiving the insulator, the housing having a latch extending therefrom;
a host circuit board having signal pads and ground pads at a mating area of the host circuit board, the host circuit board having an EMI hood covering the mating area, the housing being loaded into the EMI hood with the signal contacts engaging corresponding signal pads and with the ground tines engaging corresponding ground pads, the latch of the housing engaging the EMI hood to secure the housing to the EMI hood.

18. The connector of 17, wherein the host circuit board includes an edge and a mounting surface extending from the edge, the signal pads and ground pads being exposed along the mounting surface, the EMI hood being mounted to the mounting surface, the ground pads being positioned further from the edge than the signal pads.

19. The connector of claim 17, wherein the EMI hood includes a groove receiving the latch.

20. The connector of claim 17, wherein the EMI hood defines a receptacle above the host circuit board, the housing and insulator being received in the receptacle to mate the signal contacts and ground tines to the corresponding signal pads and ground pads.
